(19) United States
(12) Patent Application Publication
(10) Pub. No.: US 2013/0168588 A1
(43) Pub. Date: Jul. 4, 2013

(54) PRESSURE RELIEF VENTING FOR A VALVE DISK SEAL

(71) Applicant: Jason Fiske Hill, Houston, TX (US)

(72) Inventor: Jason Fiske Hill, Houston, TX (US)

(73) Assignee: AMOT CONTROLS CORP., Houston, TX (US)

(21) Appl. No.: 13/339,806

(22) Filed: Dec. 29, 2011

(51) Int. Cl. F16K 1/16; F16K 1/22

(52) U.S. Cl. 251/298; 251/305

(57) ABSTRACT

A valve (e.g., shutoff or regulating) is provided including a valve body having a fluid passage and a disc assembly. The disc assembly is pivotable within the fluid passage from an open position wherein the disc assembly is positioned within the fluid passage to provide for free flow of fluid through the fluid passage, to a closed position wherein the disc assembly is positioned within the fluid passage to substantially close off the fluid passage. The disc assembly includes a disc having a circumferential edge having a groove. A seal (e.g., an O-ring) is disposed in the groove. A pressure relief mechanism (e.g., a plurality of apertures) is provided adjacent to the seal to partially relieve differential pressure on the seal caused by fluid passing through the fluid passage. A similar valve having its seal located on the valve body is also provided.

### BACKGROUND OF THE INVENTION

This invention relates generally to valves. More particularly, the invention relates to disk valves (e.g., a butterfly valve such as used as a diesel engine shutoff valve to prevent uncontrolled runaway of the engine) having a seal and means to deter extrusion of the seal. While the embodiments of the invention which are shown and described hereinafter are directed to butterfly valves for engine shutoff, that is merely exemplary of one application of the subject invention. Hence, it is to be understood that the subject invention applies to all types of disk valves where seal extrusion may occur.

Diesel engines, in the presence of combustible gases in the atmosphere, occasionally enter a runaway condition in which the engine, without a proper device to mitigate this problem, can enter an uncontrolled acceleration. In this condition, the engine experiences runaway and, if not stopped, the engine can reach speeds that can result in destruction and/or catastrophic engine failure, and personal injury. There are a number of causes of runaway including, for example, a faulty engine governor, engine overheating or the ingestion of unregulated hydrocarbons into the combustion chamber. Such hydrocarbons may be from an external source, such as airborne gas, or from the engine itself due to a malfunction, such as failure of turbocharger oil seals.

A conventional way to stop a diesel engine is to stop the flow of fuel to the combustion chamber. However, an alternate method must be employed to stop a diesel engine in the event of runaway. The most common method, used for many years, involves blocking the air supply to the combustion chamber of the engine. Once deprived of oxygen, the runaway ceases. Accordingly, safety valves which cut off the air supply to the engine have been developed to shut off the engine in such a situation.

One type of shut-off valve placed in the air intake to the engine employs a valve disc that is biased (e.g., mechanically, hydraulically, or electrically) to be in a closed position that blocks air supply to the combustion chamber. The valve is held in an open position by a trip mechanism that is manually or power cocked to hold the valve in the open position. A solenoid or other appropriate device may be used to trip the trip mechanism to close the valve. When in the opened position, there is an unobstructed air supply to the engine. Upon runaway, the device is engaged (or disengaged), and the valve snaps into its closed position, thus cutting off the air supply to the combustion chamber, thereby starving the engine of oxygen, such that the engine stalls.

An issue with shutoff valves is a possibility of extrusion of the seal between the valve disc and valve body. Shutoff valves typically have viscoelastic seals that may move out of proper position due to static pressure or fluid dynamic forces caused by air or other fluids passing through the valve prior to full closure of the valve disc. Once a seal has extruded, the valve disc cannot return to its fully seated position. Excessive valve leakage can cause engine overrun and critical failure.

The present invention addresses numerous issues including, for example, seal extrusion during opening and/or closing of the valve against high differential pressure and seal extrusion during opening and/or closing of the valve against a high flow rate.

### BRIEF SUMMARY OF THE INVENTION

A valve (e.g., shutoff or regulating) is provided and includes a valve body having a fluid passage, an inlet side and an outlet side. The valve also includes a disc assembly. The disc assembly has a front face adjacent to the inlet side and a rear face adjacent to the outlet side and is pivotable within the fluid passage from an open position, wherein the disc assembly is positioned within the fluid passage to provide for free flow of fluid through the fluid passage, to a closed position wherein the disc assembly is positioned within the fluid passage to substantially close off the fluid passage. The disc assembly includes a disc having a front face, a rear face and a circumferential edge having a groove. A seal is disposed in the groove in the disc. At least one pressure relief mechanism is provided to partially relieve differential pressure on the seal caused by fluid passing through the fluid passage.

The pressure relief mechanism may include a plurality of apertures in the disc adjacent to the circumferential edge. The apertures pass from the rear face of the disc through to the groove. The fluid may be inlet air being supplied to an engine, for example, a diesel engine.

In another embodiment of the invention, a valve (e.g., shutoff or regulating) is provided which includes a valve body having a fluid passage, an inlet side and an outlet side. The valve also has a disc assembly. The disc assembly has a front face adjacent to the inlet side and a rear face adjacent to the outlet side and is pivotable within the fluid passage from an open position, wherein the disc assembly is positioned within the fluid passage to provide for free flow of fluid through the fluid passage, to a closed position, wherein the disc assembly is positioned within the fluid passage to substantially close off the fluid passage. The valve body further includes a circumferential groove in the fluid passage and a seal disposed in the circumferential groove. The seal provides for sealing of the fluid passage by the disc assembly when the disc assembly is in the closed position. At least one pressure relief mechanism is provided to partially relieve differential pressure on the seal caused by fluid passing through the fluid passage.

The pressure relief mechanism may include a plurality of apertures in the valve body on the outlet side adjacent to the circumferential groove, with apertures passing through the valve body to the circumferential groove.

### BRIEF DESCRIPTION OF SEVERAL VIEWS OF THE DRAWINGS

The invention will be described in conjunction with the following drawings in which like reference numerals designate like elements and wherein:

FIG. 1 is a generally rear (outlet side) isometric of a butterfly shutoff valve constructed in accordance with a preferred embodiment of the present invention, depicted with the disc of the valve in a fully closed position;

FIG. 2 is another generally rear (outlet side) isometric of the butterfly shutoff valve of FIG. 1, but depicted with the disc of the valve in a fully opened position;

FIG. 3 is a cross-sectional view of the butterfly valve of FIG. 1, taken substantially along lines III-III of FIG. 1, but showing the valve slightly opened;

FIG. 4 is a rear (outlet side) view of a disc of the butterfly valve of FIG. 1;

FIG. 5 is a cross-sectional view of the disc of FIG. 4, taken substantially along lines V-V of FIG. 4

FIG. 6 is a generally rear (outlet side) isometric view of a butterfly valve in accordance with another preferred embodiment of the present invention, depicted with the disc of the valve in a partially opened position;

FIG. 7 is a front (inlet side) view of the butterfly valve of FIG. 6; and

FIG. 8 is a cross sectional view of the butterfly valve of FIG. 6, taken substantially along lines VIII-VIII of FIG. 7.

### DETAILED DESCRIPTION OF THE INVENTION

The invention will be illustrated in more detail with reference to the following exemplary embodiments, but it should be understood that the present invention is not deemed to be limited thereto.

The butterfly valve of the present invention is preferably designed to be assembled as part of the intake manifold of a diesel engine for cutoff of intake air to the engine, however, it is considered to be within the scope of the present invention that the valve may be used in any appropriate fluid application where seal extrusion may occur. The present description is discussed with respect to a diesel engine, but is not intended to be limited thereto. The basic concept of a shutoff valve of this type is that it utilizes a manually or power latched butterfly disc held in the open (or run) position by an actuation trigger mechanism. The open or run position means that the butterfly disc is parallel with the direction of intake airflow, allowing for free passage of intake air into the engine. The valve remains in the open position until such time as the valve is tripped, whereby the disc rotates 90° under the action of a hydraulic, pneumatic, electric, or spring actuator, thereby creating a substantially airtight seal with the valve body. The restriction created by the closed disc fully throttles the engine, resulting in engine shut-down.

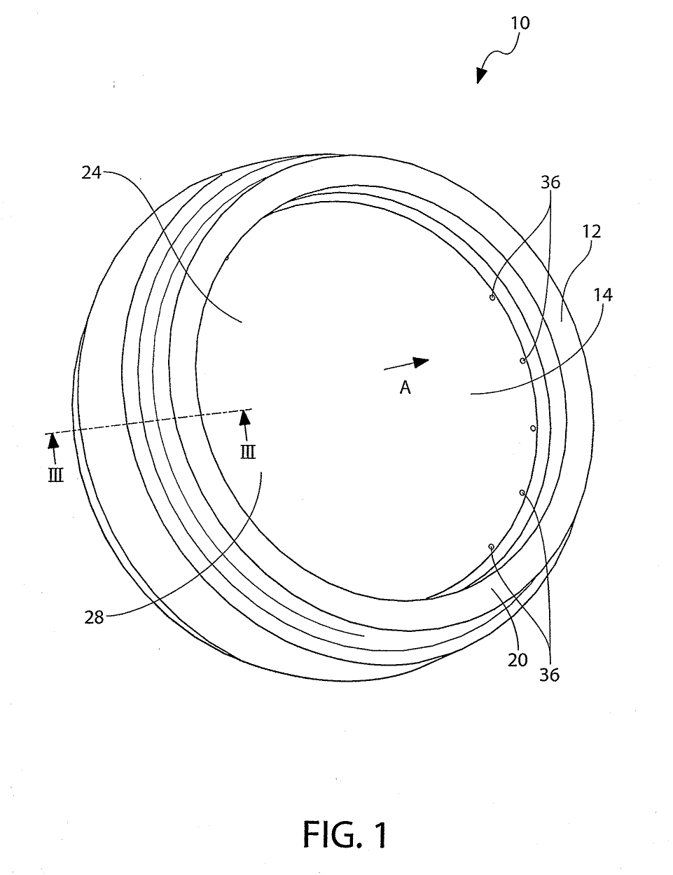

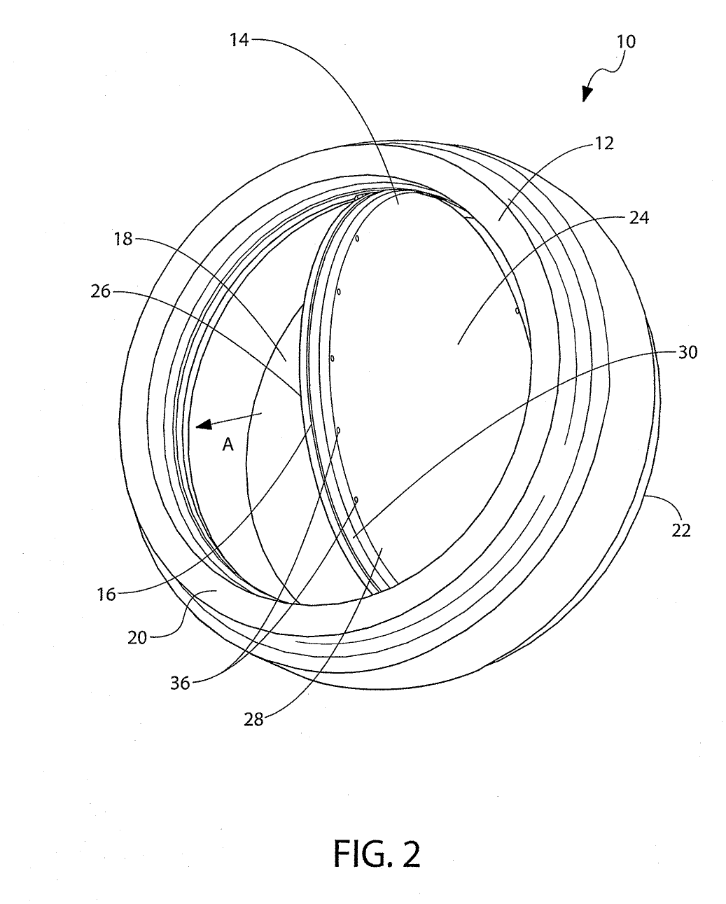

Referring now to the various figures of the drawing, wherein like part numbers refer to like elements throughout the several views, there is shown in FIGS. 1-5, a shutoff valve 10 constructed in accordance with one preferred exemplary embodiment of the present invention. The primary components of the shutoff valve 10 relevant to the present invention include a valve body 12, a disc assembly 14 and a seal 16 (FIG. 2). The valve body 12 has a fluid passage 18 (FIG. 2) therein and an outlet side 20 and an inlet side 22.

The disc assembly 14 is pivotable within the fluid passage 18 in the valve body 12 from an open position (i.e., the normal operational position for the engine application) (see FIG. 2) to a closed position, wherein intake air to the engine is substantially blocked (see FIG. 1). When in the open position, a rear face 24 and a front face 26 of the disc assembly 14 are generally parallel to the direction of airflow A (see FIG. 2) from the inlet side 22 of the valve 10 to the outlet side 20 of the valve through the fluid passage 22, thereby allowing free flow of air through the valve. When in the closed position (i.e., when stopping the engine is desired), the rear face 24 and the front face 26 of the disc assembly 14 are perpendicular to the direction of flow A and flow through the fluid passage 18 is substantially halted (see FIG. 1). When in the closed position, the rear face 24 is on the outlet side 20 of the valve body 12 and the front face 26 is on the inlet side 22 of the valve body 12.

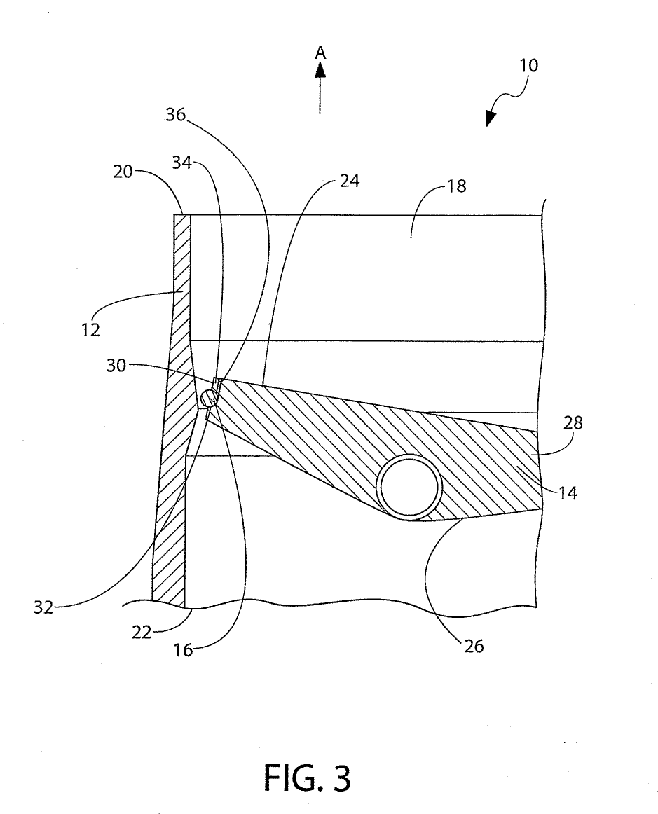

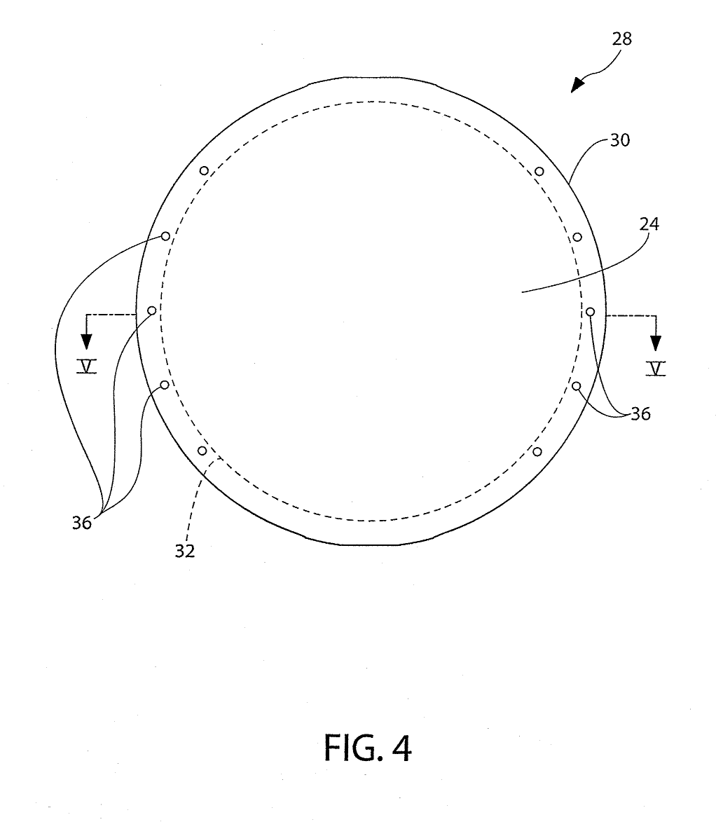

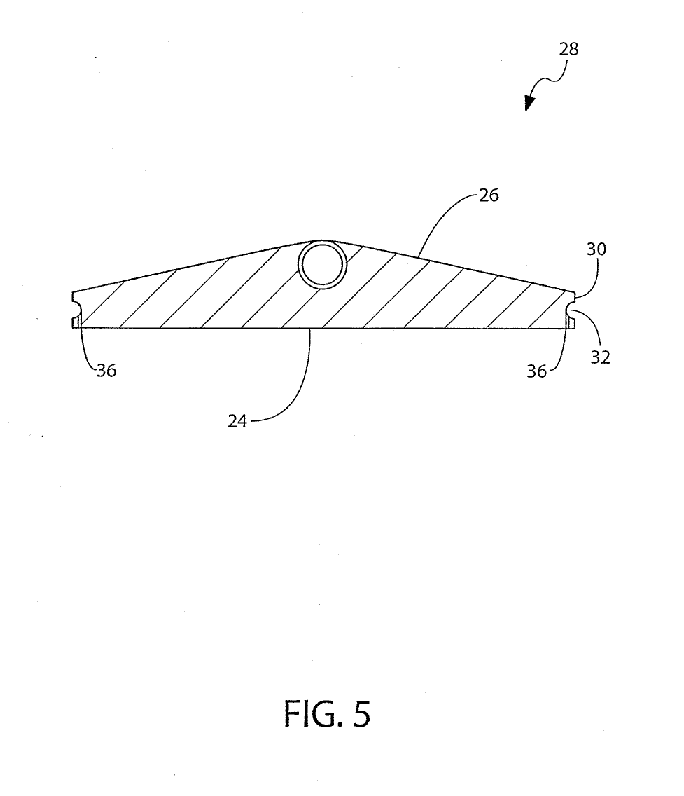

As best seen in FIG. 3, the disc assembly 14 includes a disc 28 having the heretofore identified front face and rear face as well as a circumferential edge 30 (see also FIGS. 4 and 5) extending about the entire periphery of the disc 28. The circumferential edge 30 of the disc 28 has an annular groove 32 extending fully around the edge 30 of the disc in which the seal 16, e.g., an O-ring, is disposed. A pressure relief mechanism 34 is provided to at least partially relieve differential pressure on the seal 16 caused by fluid passing through the fluid passage 18.

In a preferred embodiment of the shutoff valve 10 as shown in FIGS. 1-5, the pressure relief mechanism 34 is in the form of at least one, and preferably, a plurality of apertures 36 in the disc 14 located in the rear face 24 adjacent to the circumferential edge 30. The apertures 36 each pass from the rear face of the disc 14 through to the groove 32, thereby providing a passage for fluid to pass (e.g., the air to vent), thus relieving at least some differential pressure on the seal 16. The venting of the groove provided by the apertures 36 serves to prevent the seal from being pushed out of the groove 32 by hydrodynamic, hydrostatic, or pneumatic forces acting on the seal. The vent apertures 36 must always lead to the outlet side of the valve.

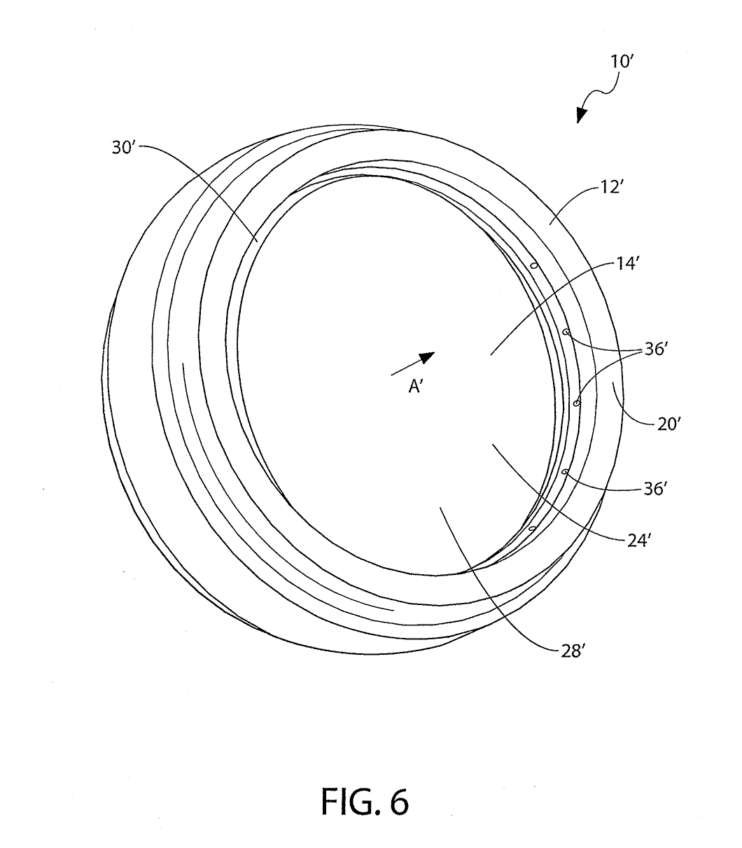

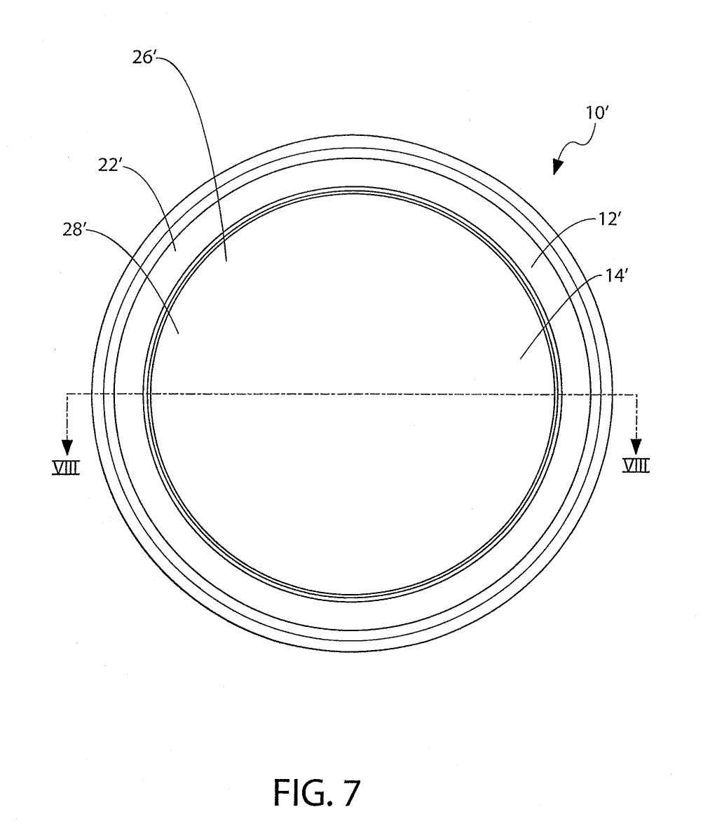

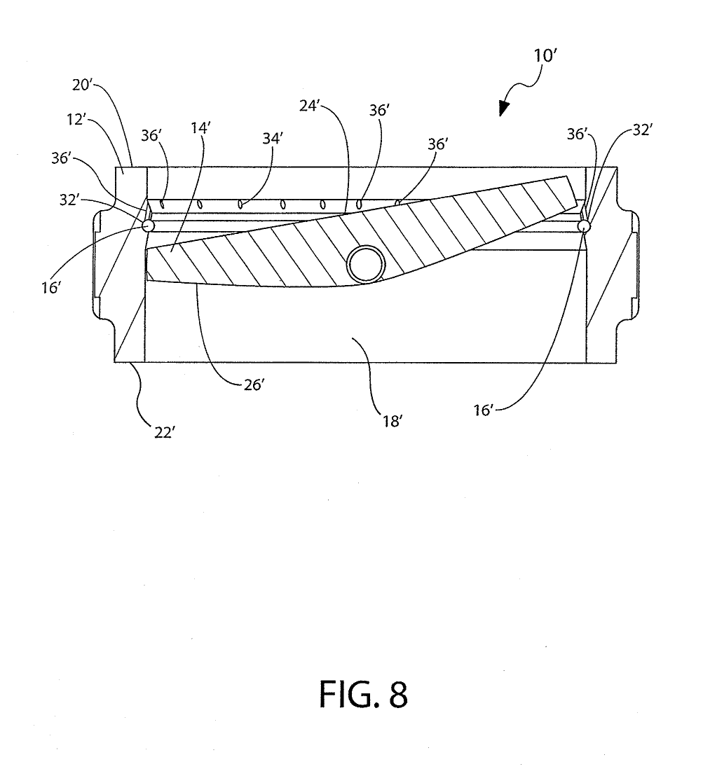

Another preferred exemplary embodiment of the present invention is shown in FIGS. 6-8. It comprises a shutoff valve 10′ having a different pressure relief mechanism 34′ than that of the embodiment of FIGS. 1-5. Here, again, the primary components of the shutoff valve 10′ relevant to the present invention include a valve body 12′, a disc assembly 14′ and a seal 16′. The valve body 12′ has a fluid (for example, air) passage 18′ therein and an outlet side 20′ and an inlet side 22′.

Again, as in the first embodiment, the disc assembly 14′ is pivotable within the fluid passage 18′ in the valve body 12′ from an open position (i.e., normal operational position of the engine) to a closed position, wherein intake air to the engine is substantially blocked, in the same manner as that of the embodiment of FIGS. 1-5. When in the open position, a rear face 24′ and a front face 26′ of the disc assembly 14′ are generally parallel to the direction of airflow A′ through the air passage 22′ of the air shutoff valve 10′, thereby allowing free flow of air through the valve. When in the closed position (i.e., when stopping the engine is desired) as shown in FIG. 6, the rear face 24′ and the front face 26′ of the disc assembly 14′ are perpendicular to the direction of flow A′ and flow through the fluid passage 18′ is substantially halted. When in the closed position, the rear face 24′ is on the outlet side 20′ of the valve body 12′ and the front face 26′ is on the inlet side 22′ of the valve body 12′.

In the embodiment of FIGS. 6-8, however, the valve body 12′ itself contains the seal 16′ and the pressure relief mechanism 34′, rather than the pressure relief mechanism being in the disc assembly 14 (as is the case of the embodiment of FIGS. 1-5). To that end, in the embodiment of FIGS. 6-8, the valve body 12′ includes a circumferential groove 32′ in the fluid passage 18′. The seal 16′ is similar to seal 16 and is disposed in the circumferential groove 32′ to provide for sealing of the fluid passage 18′ by the disc assembly 14′ when the disc assembly 14′ is in the closed position.

Like in the first embodiment, the pressure relief mechanism 34′ of the second embodiment at least partially relieves differential pressure on the seal 16′ caused by fluid passing through the fluid passage 18′. To that end the pressure relief mechanism 34′ may include at least one, and preferably, a plurality of apertures 36′ through the valve body 12′ on its outlet side adjacent to the circumferential groove 32′. The apertures 36′ pass fully through the valve body 12′ from the outlet side to the circumferential groove 32′.

As should be appreciated by those skilled in the art from the foregoing, the present invention is applicable for substantially any valve design where extrusion of a seal may take place, including butterfly valves and other types of valves, particularly for valve designs having viscoelastic seals that are significantly deformed during the process of installation or operation. The seal forms a pressure boundary between the disc and the body of the valve in the closed position. Without the inventive aspects of the present invention, static pressure or fluid dynamic forces may “uninstall” or extrude the seal. Holding the seal more tightly leads to more complicated manufacturing techniques, higher installation stress on the seal, and/or more complicated seal geometry.

Even valves that are not intended to operate at any position other than full open or full closed must pass through every position in between. Movement of the seals frequently occurs when fluid is flowing through the valve. When the valve is very close to the closed position, the risk of seal extrusion increases considerably. The risk can be fluid static in nature, i.e., if the seal is in contact with both the valve body 12, 12′ and the disc assembly 14, 14′, pressure on the seal 16, 16′ and the seal's viscoelastic properties can cause the seal 16, 16′ to extrude as the geometry between the disc assembly 14, 14′ and the valve body 12, 12′ changes during disc rotation. The risk can be fluid dynamic in nature, i.e., increased fluid velocity between the disc assembly 14, 14′ can cause a low pressure zone over the seal 16, 16′ which, in combination with higher pressure under the seal, can lift the seal out of the groove 32, 32′.

In the present invention, the seal 16, 16′ is fully functional in the closed position.

In operation of an engine on which the shutoff valve 10, 10′ of the present invention is attached, the disc assembly 14, 14′ is normally in the open position, as described above. An actuator assembly (not shown but known to those skilled in the art) contains a trigger mechanism to cause the disc assembly 14, 14′ to move from the open to the closed position.

It is also contemplated to be within the scope of the present invention that seals with pressure relief mechanisms, as described in both embodiments above can be present together. That is, two seals may be used simultaneously, with a first seal in a groove in the disc with a pressure relief mechanism, and a second seal in a groove in the valve body with a groove having a pressure relief mechanism.

The basic valve design may be similar to, for example, AMOT Model 4261/4262 butterfly valves sold by Amot Controls Corp., the assignee of this invention. The present invention operates in either “hard installations” such as integral with aluminum piping, or “soft installations”, such as along rubber hoses.

It should be pointed out at this juncture that while the butterfly valves shown in the drawings are examples of single offset pivot point valves, this invention contemplates other types of valves, such as zero offset, double offset and triple or more offset pivot point valves.

As mentioned above the valves of this invention are not limited to butterfly shutoff valves for diesel engines. Thus, the valves can be any type of disk seal valve for use with any type of fluid, e.g., air or other gases, liquids, or semi-solid slurries. In any case, the valves of this invention are provided with means for preventing seal extrusion. In particular, as described above, a seal groove on the disc of a valve or portion of the valve body adjacent to the disc has a bypass, e.g., vent apertures, to provide for some differential pressure to be relieved if and before the seal starts to extrude, i.e., move from its normal seated position.

While the invention has been described in detail and with reference to specific embodiments thereof, it will be apparent to one skilled in the art that various changes and modifications can be made therein without departing from the spirit and scope thereof.

What is claimed is:

1. A shutoff or regulating valve, comprising:
(a) a valve body having a fluid passage therein, an inlet side and an outlet side; and
(b) a disc assembly having a front face adjacent to the inlet side and a rear face adjacent to the outlet side, the disc assembly being pivotable within the fluid passage from an open position, wherein the disc assembly is positioned within the fluid passage to provide for free flow of fluid through the fluid passage, to a closed position, wherein the disc assembly is positioned within the fluid passage to substantially close off the fluid passage, the disc assembly comprising:
(i) a disc having a front face, a rear face and circumferential edge having a groove;
(ii) a seal disposed in the groove in the disc; and
(iii) at least one pressure relief mechanism to partially relieve differential pressure on the seal caused by fluid passing through the fluid passage.

2. The valve of claim 1, wherein the at least one pressure relief mechanism comprises at least one aperture in the disc adjacent to the circumferential edge, the at least one aperture passing from the rear face of the disc through to the groove.

3. The valve of claim 2 wherein the at least one pressure relief mechanism comprises a plurality of apertures in the disc adjacent to the circumferential edge, the plurality of apertures passing from the rear face of the disc through to the groove.

4. The valve of claim 1 wherein the seal comprises an O-ring.

5. The valve of claim 1, wherein the fluid passageway is adapted to receive a fluid selected from the group of consisting of gas, liquid and semisolid slurries.

6. The valve of claim 5 wherein the fluid is air.

7. The valve of claim 6, wherein the valve is a shutoff or regulating valve for halting supply of inlet air to an engine.

8. The valve of claim 1 wherein said valve is a butterfly valve.

9. The valve of claim 8 wherein said valve is selected from the group consisting of zero offset pivot point valves, single offset pivot point valves, double offset pivot point valves and triple or more offset pivot point valves.

10. A shutoff or regulating valve, comprising:
(a) a valve body having a fluid passage therein, an inlet side and an outlet side; and
(b) a disc assembly having a front face adjacent to the inlet side and a rear face adjacent to the outlet side, the disc assembly being pivotable within the fluid passage from an open position, wherein the disc assembly is positioned within the fluid passage to provide for free flow of fluid through the fluid passage, to a closed position, wherein the disc assembly is positioned within the fluid passage to substantially close off the fluid passage; with the valve body further comprising:
(i) a circumferential groove in the fluid passage;
(ii) a seal disposed in the circumferential groove, the seal providing for sealing of the fluid passage by the disc assembly when the disc assembly is in the closed position; and
(ii) a seal disposed in the circumferential groove, the seal providing for sealing of the fluid passage by the disc assembly when the disc assembly is in the closed position; and
(iii) at least one pressure relief mechanism to partially relieve differential pressure on the seal caused by fluid passing through the fluid passage.

11. The valve of claim 10, wherein the pressure relief mechanism comprises at least one aperture in the valve body on the outlet side adjacent to the circumferential groove, the at least on aperture passing through the valve body to the circumferential groove.

12. The valve of claim 11 wherein the at least one pressure relief mechanism comprises a plurality of apertures in the valve body on the outlet side adjacent to the circumferential edge, the plurality of apertures passing through the valve body to the circumferential groove.

13. The valve of claim 10 wherein the seal comprises an O-ring.

14. The valve of claim 10, wherein the fluid passageway is adapted to receive a fluid selected from the group of consisting of gas, liquid and semisolid slurries.

15. The valve of claim 14 wherein the fluid is air.

16. The valve of claim 15, wherein the valve is a shutoff or regulating valve for halting supply of inlet air to an engine.

17. The valve of claim 10 wherein the valve is a butterfly valve.

18. The valve of claim 17 wherein said valve is selected from the group consisting of zero offset pivot point valves, single offset pivot point valves, double offset pivot point valves and triple or more offset pivot point valves.
